(19) United States
(12) Patent Application Publication
(10) Pub. No.: US 2023/0052202 A1
(43) Pub. Date: Feb. 16, 2023

(54) CAP FOR A PATHOGEN SAMPLE TUBE

(71) Applicant: Fast MDX (IP) Limited, Middlesex (GB)

(72) Inventor: Richard Lewis, Northwood Middlesex (GB)

(21) Appl. No.: 17/966,709

(22) Filed: Oct. 14, 2022

Related U.S. Application Data
(63) Continuation-in-part of application No. PCT/GB2021/050904, filed on Apr. 15, 2021.

(30) Foreign Application Priority Data
Apr. 15, 2020 (GB) 2005504.2
Jun. 23, 2020 (GB) 2009586.5
Aug. 14, 2020 (GB) 2012737.9

(51) Int. Cl. G01N 35/10; B01L 3/00

(52) U.S. Cl. CPC G01N 35/1079; B01L 3/50825; B01L 2300/044; B01L 2300/021; B01L 2300/046; B01L 2200/141

(57) ABSTRACT

The invention is a cap for a pathogen sample tube, the tube having an open end and the cap being configured to secure the open end of the tube to prevent spillage of any sample stored in the tube. The cap includes a first pierceable protective film section configured to enable an automated pipette or other sample withdrawal system to pierce the protective film section and to aspirate at least some of the sample. The cap also includes a second pierceable protective film section lying underneath the first pierceable protective film section; the film sections are separated by an air gap, that is approximately 2 mm in depth. The film sections are made from a thin aluminium foil that is approximately 25 microns thick, with a thin lacquer coating on its upper side and a co-extrusion coating, such as a polymer coating, on the lower side.

### CROSS REFERENCE TO RELATED APPLICATION

This application is a Continuation-in-Part of International Publication No. PCT/GB2021/050904, filed Apr. 15, 2021, which claims priority to United Kingdom application no. 2012737.9, filed Aug. 14, 2020, United Kingdom application no. 2009586.5, filed Jun. 23, 2020, and United Kingdom application no. 2005504.2. filed Apr. 15, 2020, the entire disclosures of which are hereby incorporated herein by reference.

### BACKGROUND OF THE INVENTION

### Field of the Invention

This invention relates to a cap for a pathogen sample tube. An implementation of the invention enables safer and faster automated handling of samples in a high throughput nucleic acid extraction and Polymerase Chain Reaction (PCR) thermal cycler.

### Description of the Prior Art

In the prior art, pathogen samples are stored and transported using a simple capped tube; a sample, e.g. a mucus sample, is swabbed from a patient and the swab placed into the tube together with a buffer solution; the tube is then sealed with a conventional cap. The sealed, capped tube is taken to a diagnostics or analysis device, such as a PCR thermal cycler, and a laboratory technician uncaps the tube, manually withdraws (aspirates), e.g. pipettes out, some of the solution and pipettes that solution into a test tube or vial etc. that can be handled by the diagnostics or analysis device. There is considerable scope for human error and hence contamination and failed testing. The process is labour intensive and scales poorly.

A more detailed example: the tube can be used to hold the contents of a nasopharyngeal swab. Once the nasopharynx or other area of interest has been swabbed with a swab to collect mucus, the swab is withdrawn from the nasopharynx. The mucus may contain respiratory viruses such as Respiratory Syncytial Virus (RSV), influenza virus A & B, human parainfluenza virus (HPIV), or SARS-COV-2. The patient or medical practitioner typically uncaps a tube containing a transport buffer solution; the shaft of the swab is then broken off at a snapping point by pressing the shaft end against the inside of the tube wall and the swab head drop to the bottom of the tube and into the transport buffer solution. Viral genetic material is eluted from the pathogens in the mucus held on the swab end into the buffer solution.

Normally, these kinds of sample tubes are then closed and sealed by the patient or medical practitioner using a conventional screw cap; once the capped sample tube reaches a diagnostics or analysis device (e.g. a nucleic acid extraction instrument), the cap is manually removed by a laboratory technician. Some of the liquid buffer sample in the tube is then manually aspirated and pipetted into a tube suitable for testing by the diagnostics or analysis device. When a laboratory technician has to repeat this same procedure many hundreds of times a day, mistakes often occur: these mistakes can lead to failure of the testing, requiring multiple patients to be re-tested, and so leads to delays in diagnosis. Mistakes can also lead to contamination of laboratory equipment and pathogen transmission to the laboratory technician operating the analysis device.

### SUMMARY OF THE INVENTION

The invention is a cap for a pathogen sample tube, the tube having an open end and the cap being configured to secure the open end of the tube to prevent spillage of any sample stored in the tube;

in which the cap includes a first pierceable protective film section configured to enable an automated pipette or other sample withdrawal system to pierce the protective film section and to aspirate at least some of the sample.

In one implementation, the cap includes a plastic body with a screw thread that securely attaches to a thread around or within the tube; the first pierceable protective film section is a thin aluminium foil with a plastic or polymer coating on one side that is attached across an opening in the plastic body, e.g. by heat welding. The film section can be circular. The cap may also include a second pierceable protective film section lying underneath the first pierceable protective film section; the second pierceable protective film section is again a thin aluminium foil with a plastic or polymer coating on one side that attached across an opening in the plastic body, e.g. by heat welding. The first and second pierceable protective film sections are separated by an air gap that is approximately 2 mm in depth; this structure provides compliance with UN3373 Category B, Packaging Requirements for Biological and Infectious Substances.

This approach removes the need for the technician to have to manually remove the cap in order to be able to withdraw some or all of the sample from within the tube. It is hence safer, allows for faster processing of samples and more reliable than conventional approaches. The structure of the cap makes it far more secure and reliable than a simple rubber septum and far less likely to snag against or interfere with the operation of automated pipette or other sample withdrawal system.

Further details are in the Appendix.

### BRIEF DESCRIPTION OF THE DRAWINGS

The accompanying Figures show various implementations of the invention.

FIG. 1 shows a perspective view of a pathogen tube, closed with a cap that includes a protective, pierceable film section; a swab head has sunk to the bottom of the buffer transport solution in the tube.

FIG. 2 shows top and side views of the complete swab, including head and shaft.

FIG. 3 shows a perspective view of a cap that includes a protective, pierceable film section.

FIG. 4 is a perspective cross section view through the cap.

FIG. 5 shows top and side cross-sectional views of the cap.

FIG. 6 shows a side cross-sectional and a side view of the tube, with an expanded view of the top of the tube.

FIG. 7 side cross-sectional view of the cap secured onto the tube.

FIG. 8 is a bottom perspective view of the cap, showing locking tabs.

FIG. 9 is a close up view of the top of the tube, showing the cap locking mechanism.

FIG. 10 is a top down cross-sectional view of the tube, showing the cap locking mechanism.

FIG. 11A shows a kit comprising a cap, tube containing transport buffer solution and a swab.

FIG. 11B shows a cap with a push-on, pull-off lid.

FIG. 11C shows a cap with a screw-on, screw-off lid.

FIG. 12 is a perspective view of a rack holding an array of capped tubes.

FIG. 13 is a cross-sectional view of the rack holding six capped tubes

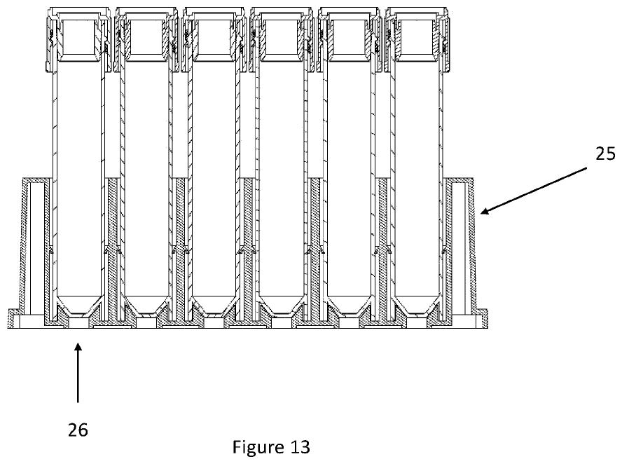

FIG. 14 are engineering drawings of the rack, showing various views and cross sections.

FIG. 15 is a close up sectioned view of the flange in the tube holder of the rack that stops tubes being drawn up from the rack.

FIG. 16 is a perspective view of the cap.

FIG. 17 is a side and perspective view of a set of four racks.

FIG. 18 is a schematic representation of an auto-pipette system engaging with a set of eight capped tubes and transferring buffer solution from those capped tubes into the standard tubes used in the PCR. A side and top view of the capped tubes is shown.

FIG. 19 is a cross-sectional view of capped tube in which the shaft of the swab is inserted into a socket in the underside cap.

FIG. 20 shows a tube, cap and swab, in which the cap includes a socket for the shaft swab, positioned on the top of the cap, which is inverted when the tube is to be closed by the cap.

FIG. 21 are cross-sectional views of a capped tube in which the tube includes an internal partition to prevent the swab and shaft interfering with a pipette inserted into the tube.

### INDEX TO FIGURES

| | |
|---|---|
| Cap | 1 |
| Pathogen sample tube | 2 |
| Transport buffer solution | 3 |
| Swab head or end | 4 |
| Thin, pierceable film section | 5 |
| Upper pierceable film | 5A |
| Lower, pierceable film | 5B |
| Air gap between films | 6 |
| Circular cap ridge | 7 |
| Central tapered bung | 8 |
| Annular sealing surface | 9 |
| Swab | 10 |
| Swab shaft | 11 |
| Annular top of the tube | 12 |
| Cap internal thread | 15 |
| Tube thread | 16 |
| Annular ridge on tube | 17 |
| Ramp feature on ridge | 18A |
| Opposite ramp feature | 18B |
| First tab inside cap | 20 |
| Second tab inside cap | 21 |
| Stop feature on ridge | 22 |
| Plastic film over buffer | 23 |
| Push fit cap | 24A |
| Ridge on push fit cap | 24B |
| Screw fit cap | 24C |
| Thread on screw fit cap | 24D |
| Rack | 25 |
| Aperture in rack base | 26 |
| Annular, ribbed ring | 27 |
| Tube holder | 28 |
| Circular groove in cap | 30 |
| Vertical cap ridges | 31 |
| Ridge base | 32 |
| Control tubes | 34 |
| Mating socket in cap for swab | 40 |
| Cap protruding registration feature | 41 |
| Internal double threading to cap | 42 |
| Swab shaft break point | 43 |
| Partition in tube | 50 |
| Tube protruding registration feature | 51 |
| Additional top film layer | 52 |
| Upstand for top biosecurity film | 53 |
| QR code | 55 |
| Multi-tipped auto-pipetter | 60 |
| Pipette | 61 |
| Septum-capped tube | 62 |
| Transport rack | 63 |

### DETAILED DESCRIPTION

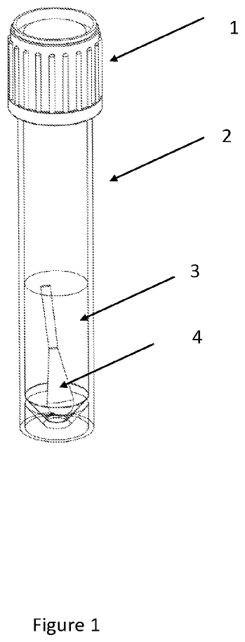

Several implementations of this invention will now be described. The pathogen sample system implemented by this invention provides a safe way to transport and process a tube containing a transport buffer or any animal or human bodily fluid or other tissue sample, or plant material (we will refer to these as ‘samples’) that may contain highly infectious pathogens (e.g. viruses, parasites, bacteria, bacteriophages or funguses). FIG. 1 shows this implementation: a cap 1 seals a tube 2; the tube contains transport buffer solution 3 and a swab head or swab end 4 that has sunk to the bottom of the tube 2.

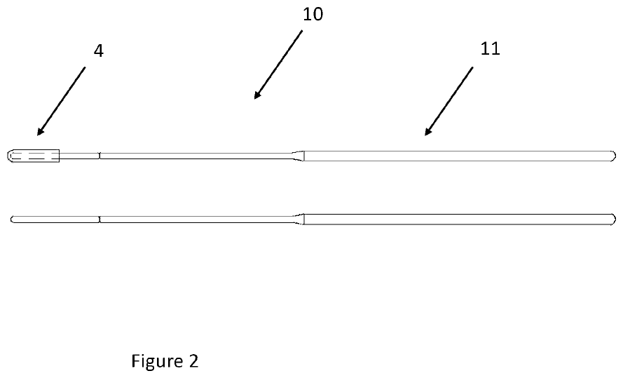

As an example, the tube can hold the contents of a nasopharyngeal swab which has been used to sample mucus from the nasopharynx; the swab and mucus may contain respiratory viruses such as RSV, influenza virus A & B, parainfluenza virus or SARS-COV-2. FIG. 2 shows a typical swab 10 in top and side view; it is made up of swab head or swab end 4 and swab shaft 11. Once the nasopharynx or other area of interest has been swabbed with a swab 10 to collect mucus, the swab 10 is completely extracted from the patient's nasopharynx etc. The shaft 11 of the swab 10 is then pressed at an angle against the inside wall of the sample tube 2 until the swab head 4 breaks from the shaft 11 at a pre-defined snapping point and the swab head 4 drops into the transport buffer liquid 3, sinking to the bottom of the tube 2, as shown in FIG. 1.

Normally, conventional kinds of sample tubes are closed and sealed using a simple plastic screw cap; once the sample tube reaches a diagnostics or analysis device, such as a nucleic acid extraction platform, the cap is manually removed; the sample in the tube is then manually aspirated and pipetted into a tube suitable for testing by the diagnostics or analysis device. Human error can arise during these manual processes, risking contamination of the person operating the analysis device, and mistakes that require testing on the patient to be repeated.

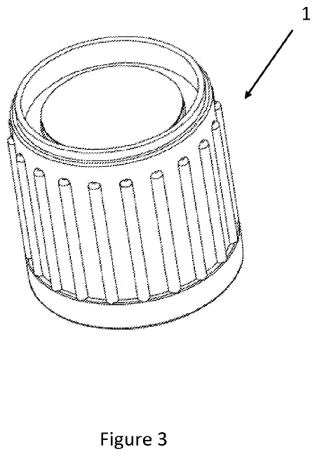

The primary implementation of the invention is shown in FIG. 3; a specialised cap 1, which will be described in more detail, closes a pathogen sample tube and prevents an infectious pathogen coming into contact with, or being ingested or inhaled by, the technician performing the test. This is achieved by removing the need for the technician to have to manually remove the cap 1 in order to be able to withdraw the sample (in this case, the transport buffer solution 3 that elutes the pathogenic genetic material from swab head 4) in the tube 2 and transfer it into a test tube or other container that can be handled by a diagnostics or analysis device. The cap 1 shown in FIG. 3 is the cap shown in FIG. 1.

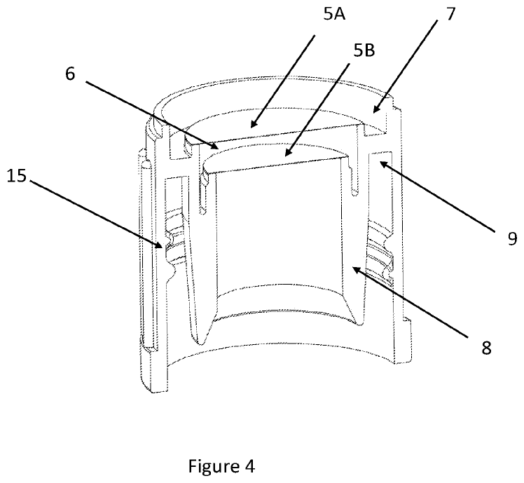

We will now describe the structure of the cap 1 that ensures safe transportation of the sample 3, 4 in the tube 2 and eliminates the need for the technician to have to manually remove the cap 1 from tube 2 in order to withdraw the transport buffer solution 3 from tube 2. As noted above, the cap 1 does not need to be removed from tube 2 to enable its contents 3 to be transferred into the test tube or other container used in the diagnostics or analysis device: instead, as shown in the cap cross-section in FIG. 4, the cap 1 includes a thin, pierceable metal and plastic film section 5 (in this example made up of upper 5A and lower 5B film sections) that can be pierced during the automated process used in an auto-pipette station or test platform: a pipette tip or needle or other sample withdrawal system is automatically lowered through the film section 5, piercing it, and then lowered further down into the tube 2 to aspirate the sample—e.g. to transfer some of the transport buffer 3 that includes eluted contents of the swab head 4 or the bodily fluid, up and into the auto-pipette station or test platform and then into a second container that is suitable for further processing. The pipette tip etc. is then withdrawn from the second container and is either discarded into a waste bin or may be discarded into the tube 2; both are then discarded into a biological hazards waste bin.

The pierceable film is, in one implementation, a thin aluminium foil, approximately 25 microns thick, with a thin lacquer coating on its upper side and a co-extrusion coating (e.g. a polymer coating) on the lower side; the film provides a barrier to light, water vapour, oxygen, and is tamper evident. It is designed to be readily pierced by a pipette tip used in the diagnostics or analysis device; this pipette tip can be a disposable tip. Other material combinations are possible, such as a film that is made entirely of a thin plastic or polymer film. The plastic film may be, without limitation, polytetrafluoroethene (PTFE), polyethylene, polypropylene, a poly(meth)acrylate, polyethylene terephthalate (PET) or acrylonitrile butadiene styrene (ABS).

The pierceable film is, in this implementation, a disc that forms the central, circular section of the cap 1; in one implementation, it is approximately 11.6 mm in diameter. A circular ridge surrounds the disc, protecting the disc from being inadvertently damaged.

There can be two parallel pierceable film discs in the cap; an upper disc 5A and a lower disc 5B, separated by a small gap 6 (e.g. an air gap); in one implementation, the lower disc 5B is slightly smaller than the upper disc 5A (e.g. 9.4 mm in diameter) and the air gap 6 is approximately 2.2 mm; this enables the lower disc 5B to be heat welded into the cap 1 from above, and then the larger disc 5A to be heat welded to the cap 1 from above. If the discs 5A, 5B were the same size, then you would need to heat weld the lower disc from below and the upper disc from above.

Both films 5A, 5B may be made of the same material and hence have the same properties. Alternatively, the second, lower pierceable film 5B may be a septum sealing film made generally from silicone or butyl rubber. This is acts as a self-healing or self-sealing film once the sample has been aspirated and the pipette or needle removed; it re-seals the tube in order to prevent leakage of the pathogen into the platform interior from an otherwise open tube. The rubber film is suitably not scored or otherwise weakened in a way that may compromise the film's ability to re-seal.

Having 2 layers of pierceable film above the sample greatly increases safety; if there were just a single film layer, and that were accidentally punctured through mishandling, then samples (and pathogens) could escape. By providing two separate film layers, that risk is greatly reduced. It also provides compliance with UN3373 Category B (Packaging Requirements for Biological and Infectious Substances; United Nations Economic Commission for Europe (UNECE) European Agreement concerning the International Carriage of Dangerous Goods by Road ADR applicable as from 1 Jan. 2015).

Because the pierceable film discs 5 are centrally positioned in the cap 1, a standard autopipette platform will accurately lower its pipettes through the centre of each disc; this requires no re-programming of the autopipette platform. Where the tube includes a swab, the swab is designed to sink to the bottom of the tube, as shown in FIG. 1, and hence not to block the pipettes.

In some embodiments, the cap has an upper plastic film and a lower rubber film. The present inventors have surprisingly found that such an arrangement allows for the rubber film to be pierced by a glass or plastic pipette such that sufficient air can enter the tube, thereby allowing some or all of the sample to be aspirated out.

In some embodiments, the upper plastic film is a pre-cut plastic film. The present inventors have surprisingly found that efficient automated aspiration with glass or plastic pipettes can be achieved with a combination of an upper pre-cut plastic film and a lower rubber film.

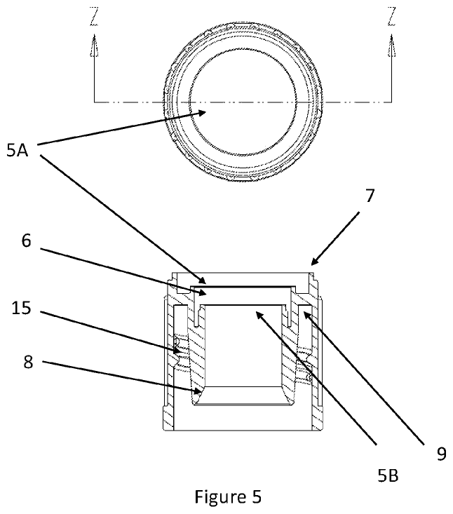

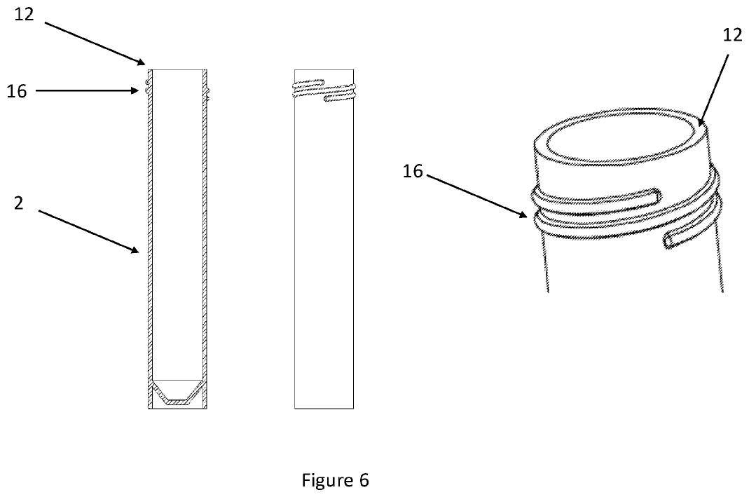

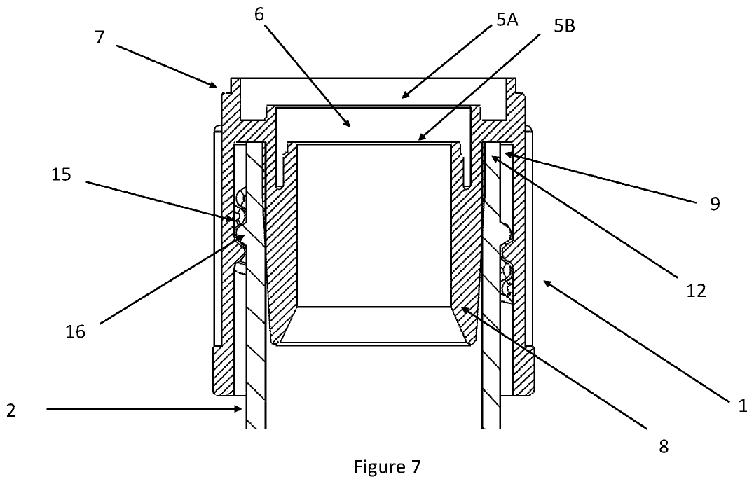

After the swab head 4 is added to the tube 2, the tube 2 is then fully sealed by screwing or clipping together the specialised cap 1 on to the mouth of the tube. The cap has a central tapered deformable cylindrical section 8 that acts to bung the cap 1 to prevent leaks. An internal annular sealing surface 9 inside the cap 1 seals against the top 12 of the tube 2 when the when the cap 1 is fully closed onto the tube 2 by turning the cap on its internal thread 15, which engages with tube thread 16. FIG. 5 includes a cross-sectional, and a top view of the cap 1. The cross-section side view shows the thin, pierceable metal and plastic film section 5 made up of the upper pierceable film 5A and the lower, pierceable film 5B, separated by air gap 6. FIG. 5 shows the circular cap ridge 7, internal thread 15, central tapered deformable cylindrical section in the cap 8 that, as noted above, acts to bung the cap 1 to prevent leaks. Internal annular sealing surface 9 inside the cap 1 seals against the top 12 of the tube 2 when the cap 1 is fully closed onto the tube 2. FIG. 6 shows the tube 2, including tube thread 16 that the cap thread 15 engages, and the annular top 12 of tube 2 that, when the cap 1 is fully closed, seals against annular sealing surface 9 in the cap 1. FIG. 7 shows the cap when locked on to the tube 2, in cross-section.

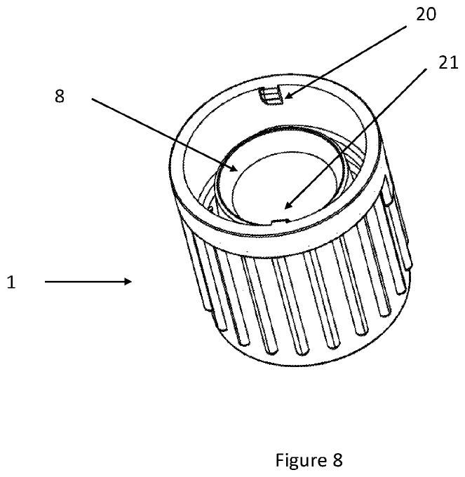

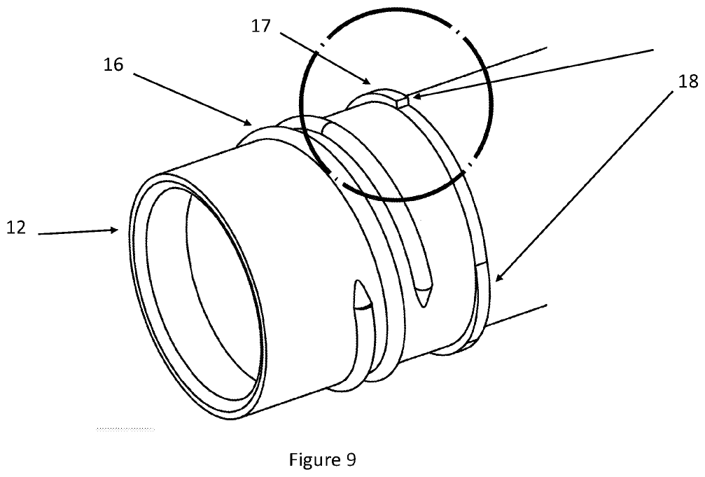

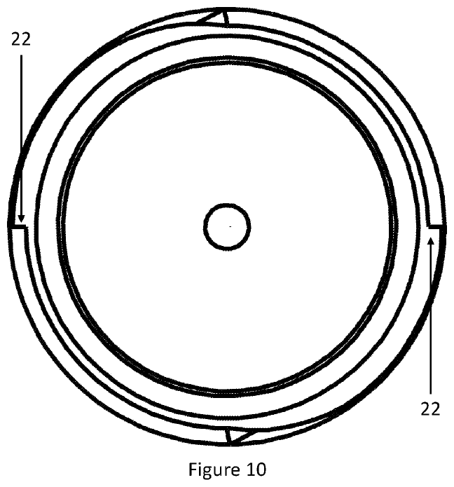

The cap 1 may lock on to the tube so that it cannot be readily removed, using a mechanical lock shown in FIGS. 8, 9 and 10. Cap 1 includes a pair of opposed tabs 20, 21 or other features, as shown in FIG. 8, at the base of the cap. Cap 1 is screwed down onto the tube with its internal thread 15 engaging with the thread 16 on the tube 2. Below thread 16 on the tube 1 is an annular ridge 17 with a ramp feature 18, as shown in FIG. 9. As the cap 1 is screwed down on tube thread 16 it approaches the end of its travel; at this point, one tab 20 in the cap reaches the ramp feature 18 on the tube. Tab 20 rides up the ramp feature 18A as cap 1 is turned further down onto tube 2, and the ramp feature 18A forces the cap 1 out of shape until that deformed part of the cap springs off the edge of the annular ridge 17 and clicks into position below annular ridge 17. At the same time, the other tab 21 or feature rides up the other ramp feature 18B, on the opposite side of tube 2 to ramp feature 18A, and deforms the associated part of the cap 2. Both tabs 20, 21 are hence now locked beneath the annular ridge 17; they lock with an audible click to confirm locking. The cap 1 can be twisted in the opposite direction only a very limited amount until tab 20 and 21 hits a respective pair of stop features 22 in the annular ridge 17; the cap can be rotated back up no further and is hence locked; the tabs 20, 21 are now permanently located beneath annular ridge 17. Unlike some other designs of locking cap, a user cannot deform the cap 1 to get the cap 1 back off tube 2.

Also, as the tab 20 clicks into place below annular ridge 17, annular sealing surface 9 in the cap seals against the annular top 12 of the tube 2. Accurate, matching spacing of the tube thread 16 from annular ridge 17 and also of cap thread 15 from tab 20 is required.

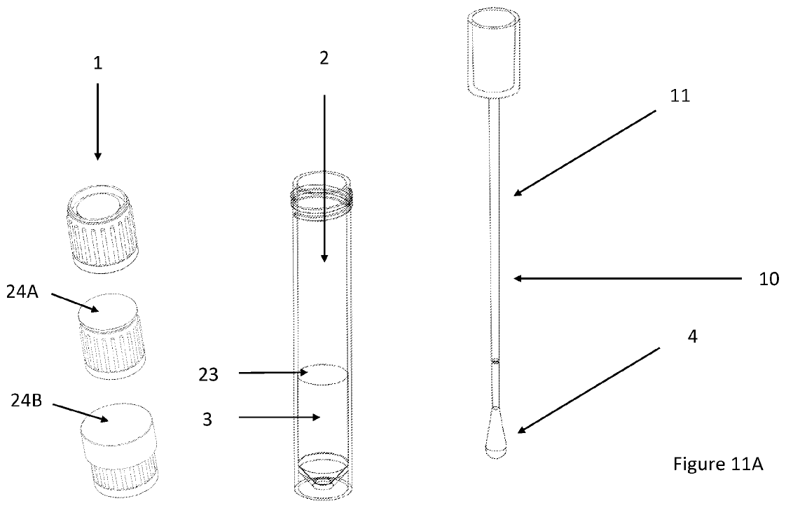

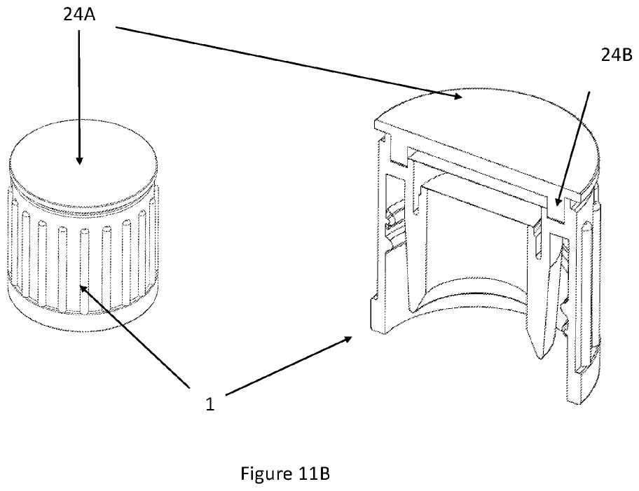

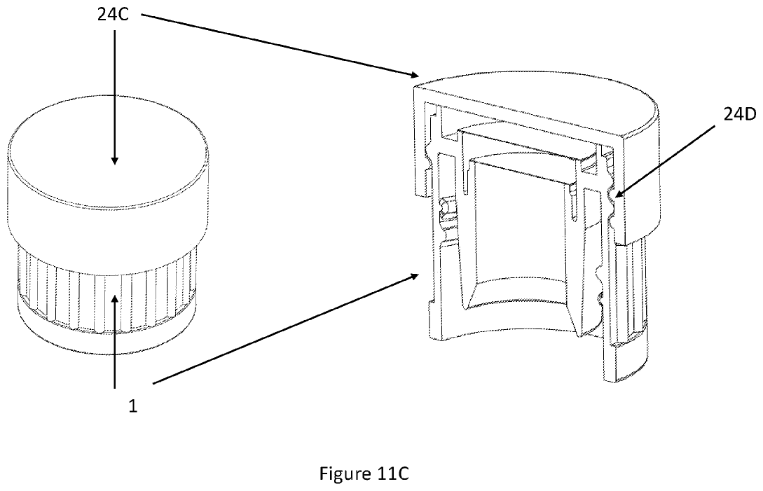

This specialised cap with one (or more) pierceable film sections 5 can be part of the kit supplied to enable a swab to be taken; the kit could then include (a) a tube 2 with a buffer solution 3; the buffer solution is covered with either a protective plastic film 25 to prevent spillage or a simple, conventional, disposable cap (not shown); (b) the specialised cap 1 with a pierceable film 5; the simple cap 1 is screwed or attached to the tube 2 for storage and transport to the end-user of the swab after a sample is taken; (c) a swab 10 made up. FIG. 11A shows this.

Note that the locking cap 1 shown in FIG. 8 can only be used to seal the tube before use (i.e. before adding the swab) if it is not actually locked down, e.g. is only partially twisted down. Alternatively, the tube 2 can be sealed with a detachable or pierceable film 23 and closed with a conventional cap, or closed with a non-locking version of the cap 1.

Both the locking and non-locking versions of the specialised cap 1 come in two further variants. The first variant of the cap, shown in FIG. 11B, includes a detachable lid 24A that has an annular ridge 24B on its base that can be pushed and secured with an interference fit into an annular recess in the top of cap 1. Detachable lid 24A protects the pierceable films 5 during transportation and handling and can be easily pulled off before the capped tubes go into the automated liquid handling platform.

The second variant of the cap, shown in FIG. 11C, includes a screw fit lid 24C that has an internal thread 24D that engages with a thread on the outside of cap 1; screw fit lid 24C protects the pierceable films 5 during transportation and handling and can be easily screwed off before the capped tubes go into the automated liquid handling platform.

As noted above, a sample is then taken by the user (i) sampling mucus in the nasopharynx using the swab 10; (ii) unscrewing a simple disposable cap 1 off the tube 2 (iii) breaking the swab head 4 off from its shaft 11 by pressing it against the inside wall of the tube 2 and so allowing the swab end 4 to drop into the buffer solution 3; (iv) replacing the simple cap with a specialised cap 1 onto the tube. The system is designed to ensure that the swab head 4, once broken and having absorbed some of the liquid transport buffer 3, sinks sufficiently to the bottom of the tube 2 to ensure the pipette tip in the diagnostics machine does not foul on the swab end 4 when aspirating out some of the sample. The shaft 11 of the swab 10 is made from polystyrene and the flocked swab end 4 is made from nylon. The materials from which the tubes, swabs and caps are selected must be able to withstand heating up to 100 C, in order to inactivate pathogens, e.g. SARS-COV-2 prior to transporting or upon receipt by the test centre, prior to insertion into the platform and the perforating of the seal/s. The same plastics should also be selected in order to withstand refrigeration at 4 C and freezing at both −20 C and −80 C.

As noted above, the system is not limited to handling tubes with swabs in a transport buffer, but can be used wherever a tube contains a sample that needs to be analysed. It can therefore be used wherever any animal or human bodily fluid or other tissue sample, or plant material (which may be liquified prior to analysis) needs to be aspirated by a pipette or needle platform that then transfers the sample into an analysis platform, such as a high throughput nucleic acid extraction and PCR thermal cycler.

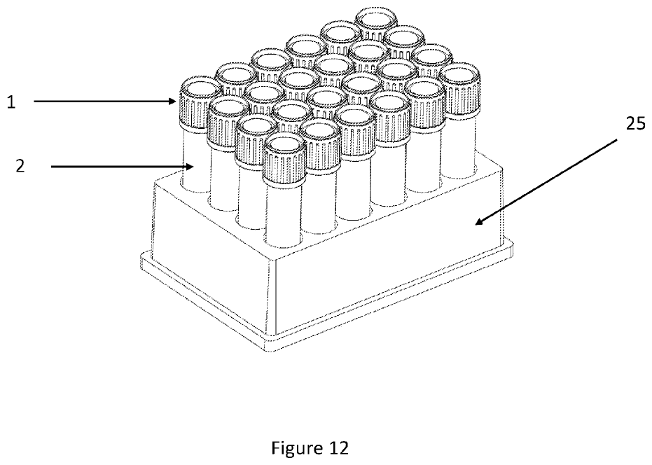

Once the cap 1 is securely attached to the tube 2, the tube 2 is then moved to a diagnostics machine: it is placed, together with a number of other similar tubes, in a transportation and handling rack 25 that conforms in size to the ANSI/SLAS (SBS) standard for microplates; this ensures that the rack 25 can be processed by a liquid handling platform or by an analysis device (e.g. PCR thermal cycler or nucleic acid extraction platform) designed to handle standard microplates, such as standard 6×4 array microplates. A rack 25 holding twenty four capped tubes 2 in a 6×4 array is shown in FIG. 12. The rack 25 can be used for transporting the tubes a short distance; in many settings, the samples will be taken in a hospital and that hospital will also have the analytics (e.g. PCR) system.

The rack can also be used where the tubes are moved many miles to a centralised laboratory; in either case, it may be desirable to wrap the rack in sealable plastic bag which together is placed into a conformable sealable carton or box to secure all the tubes in position.

In some cases, heat welding the plastic film across the top of all tubes in the rack, or placing a lid over all the tubes, is desirable.

Each tube 2 has a QR code or other unique ID, typically on its base. The base of the rack then includes an aperture 26 under each tube holder; when a tube is placed into the rack, the QR code is hence visible and can be read by a computer vision system (not shown) in the analytics device, enabling the device to automatically and reliably identify each tube, and hence enabling the results it generates to be automatically associated with each tube.

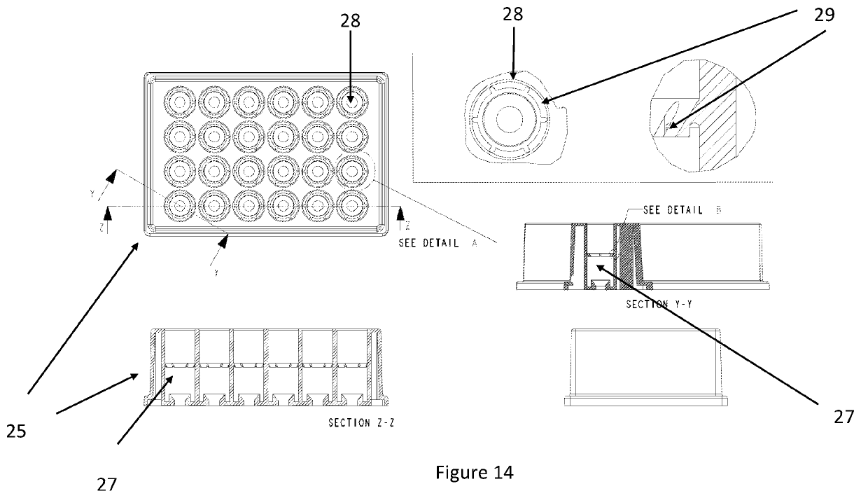

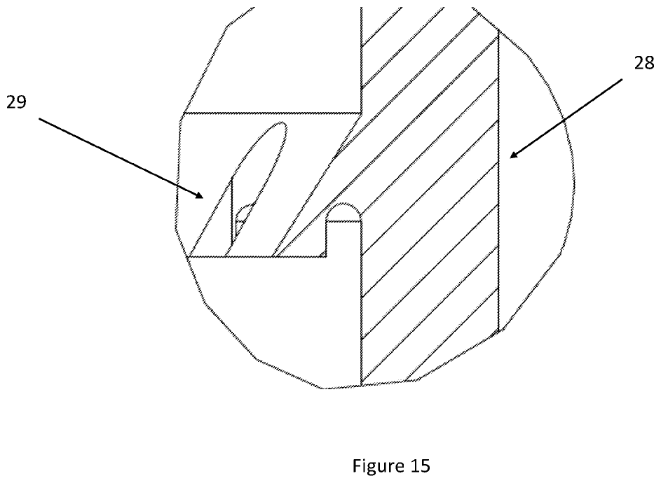

The rack typically will also be QR coded, or another ID bar coded, and holds twenty four tubes with an interference fit, sufficient to prevent a pipette or other sample withdrawal device, when withdrawing from the tube, from snagging against the pierceable film section or sections and lifting the tube up and out of the rack. FIG. 14 shows the interference fit mechanism: an annular, ribbed ring 27 part way up each cylindrical tube holder 28. The ribbed ring comprises six downward sloping flanges 29, each with a triangular cross-sectional (shown more clearly in FIG. 15) shaped so that a tube 2 can be inserted into a tube holder 28 in the rack 25 and deform each flange 29 downwards as the tube 2 is inserted. The flanges 29 resist upward movement of the tube 2 and hence secure the tubes in their position in the rack 25. As auto-pipettes (not shown) withdraw up and out of a tube 2, they would tend to drag the tube 2 upwards, due to their tight fit against the pierceable metal and plastic film 5, were it not for the flanges 29, which prevent the tubes moving upwards.

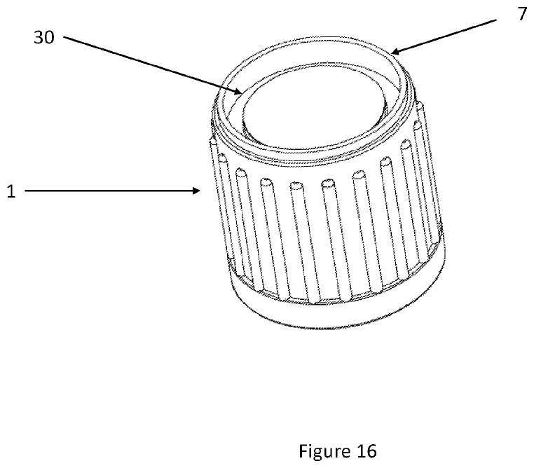

There are other ways to ensure that the capped tubes remain securely in the rack 25 during the insertion and withdrawal of the auto-pipettes. For example, a lid, with 24 holes, can drop down onto the tops of the caps or tubes, securing the caps and tubes against the rack 25 and preventing them from being dislodged by the auto-pipettes. The side of each hole in the lid can include a circular ridge that is shaped to engage with a circular groove 30 (See FIG. 16) running around the top of each cap; alternatively, the side of each hole in the lid can include a circular groove shaped to engage with a circular ridge 7 running around the top of each cap 1. Other ways of mechanically engaging the lid against the cap to secure the cap and tube in position can be devised; for example, there can be a reverse feature in the rack, or each tube could have to be screwed or bayonet mounted or fitted or otherwise locked into the rack.

Each rack may include one or more locking features that secures the rack onto a baseplate of the auto-pipette or other liquid handling platform; this stops the rack being lifted up when the pipette tips are lifted up and have caught against a pierceable film section 5. One or more simple mating features on the rack, that engage with one or more returns or other corresponding features in the baseplate, may be used.

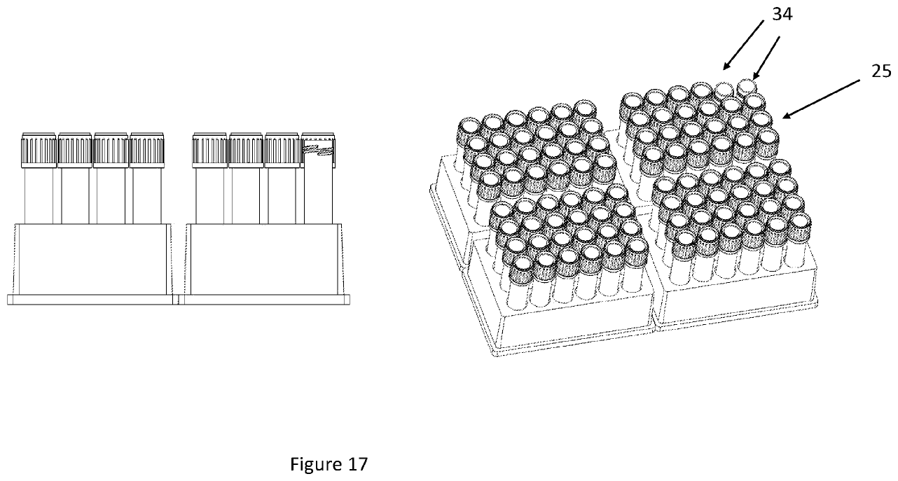

Some diagnostics machines will hold four of these racks 25, as shown in FIG. 17, enabling the processing of up to ninety six tubes, with typically eight or ninety six auto-pipettes simultaneously piercing the double film layer in each of the caps for the eight or ninety six tubes and aspirating the sample in each tube. Usually, only ninety four tubes will contain actual patient samples; two tubes 34 will be control tubes: one containing a positive control, e.g. with synthetic nucleic acid of the pathogen being looked for, to enable false negatives caused by machine or system error to be detected; and one with no nucleic acid, to enable false positives caused by contamination to be detected.

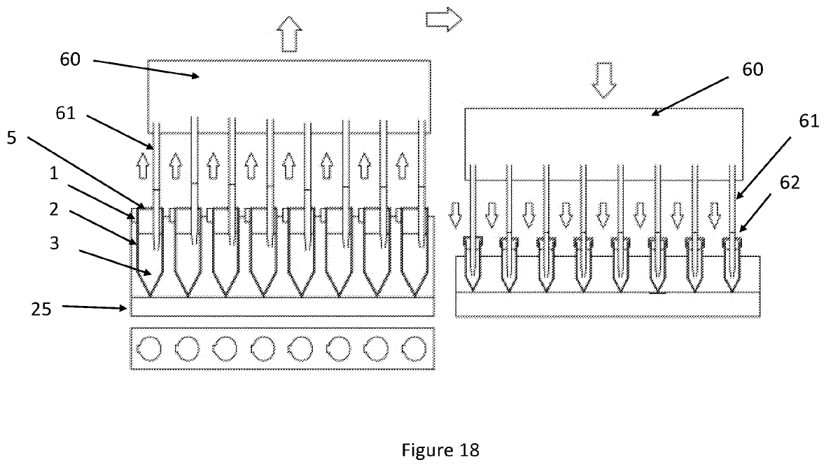

The racks are then bulk processed in the diagnostics machine by an auto-pipette system, as shown schematically in FIG. 18, which shows the contents of eight pathogen-secure tubes 2, each with a specialised cap 1, and each secured in rack 25, being aspirated by a multi-tipped auto-pipetter 60 with eight pipettes 61. The auto-pipetter 60 collects transport buffer 3 (into which a sample has been eluted) from each tube 2 by piercing the double film section 5 in each cap 1 using each pipette 61 and then withdrawing or aspirating the liquid from each tube 2. Auto-pipetter 60 then moves across to the right, to a rack of eight septum-capped tubes 62. It then lowers the pipettes 61 into these septum-capped tubes 62 and forces out the transport buffer 3 into each of the septum capped tubes 62, for localised liquid handling in a test platform.

Once the aspiration is complete, the racks are withdrawn from the diagnostics machine. Then, to ensure that the contents of the tubes can be safely disposed of, a single plastic (e.g. polyester) sheet is typically heat bonded over all 24 tubes in a rack (or all 96 if four racks are being simultaneously sealed). The sheet can bond to the circular ridge running around the top of each cap. The entire, sealed rack, can now be lifted, maneuvered and deposited into a biological materials hazard waste bin. Tubes could also or alternatively be singularly resealed using bungs, or caps similar to the simple, conventional caps previously mentioned, or singularly or in strips of 8 be sealed with either an adhesive coated film or a heat welded film.

In addition, the pipette tips used in the diagnostics machine can be plastic or glass disposable pipette tips; because the thin aluminium film is designed to be readily pierced by these plastic or glass disposable pipette tips, there is no need to use costly metal needles or metal pipette tips for the aspiration. The pierceable film(s) may also be large enough so that the complete disposable pipette tip, after use, can be ejected and dropped into the sample tube, through the pierceable film(s), where it is retained for biosecurity and to reduce the volume of waste material.

The pierceable films can be designed to self-seal after the pipette tips have been withdrawn; however, by automatically wrapping the entire rack in plastic, this is not essential.

As noted above, these features eliminate the need for manual uncapping of a tube and the manual pipetting of the buffer solution from the tube and into the different sort of tube used by the analytics device. Manual transfer is normally done by a lab technician unscrewing a standard cap from a tube, then carefully and manually inserting a pipette into the sample/buffer in the tube, to withdraw some of the sample/buffer, and then carefully and manually extracting the pipette and then moving the pipette over to the tubes or wells used by the analysis platform (e.g. a high throughput nucleic acid extraction and PCR thermal cycler) and gently pipetting the sample/buffer out into the well/tube.

It can take a significant time to complete this process for an analysis platform that can handle say 48 or 96 samples simultaneously; this is a major bottle neck to the entire process. With the present system, handling is faster and multiple tubes can be simultaneously and automatically penetrated using a conventional auto-pipette platform; the sample contents of all tubes can then be safely and automatically transferred to the wells/tubes used by the analysis platform.

So if the analysis platform works on 48 samples simultaneously, then in this system, 48 sealed tubes can be presented in an array, and then 48 pipette tips then automatically descend, pierce the tube films, withdraw samples and transfer them into an array of 48 wells/tubes used by the analysis platform, enabling far higher throughput. Further, this approach is more accurate, eliminating manual mis-handling errors that can account for an up to 20% error rate. Because it is fully automated, it eliminates the need for skilled lab technicians for the pipetting and is also safer from the cross-infection perspective, since no lab technician is exposed at the pipetting stage. It can also be undertaken within a fully sealed housing which can be flushed with viricidal or anti-bacterial vapour or ultraviolet light, eliminating the need for a large and costly biosafety certified environment.

In summary, the automated, or robotic handling enabled by this invention:
reduces human handling errors
automatically tracks each sample using the QR or similar code on the sample tube
minimises the risk of infection to the technician handling the sample
reduces the need to use the platform in a high-level Biosafety laboratory environment
improves efficiency by working 24/7
reduces the skill requirement level of the laboratory technician
eliminates the need for the laboratory technician to use the Personal Protective Equipment (PPE) required for Biosafety Level 2, 2+, 3 and 4 laboratories

There are multiple variants of the present invention.

Variant A is that the tube is provided to the end-user pre-filled with buffer solution and the interior of the tube is sealed prior to patient use, e.g. sealed at its mouth, with a plastic, heat welded or glued-in seal that is there to retain the transport buffer within the uncapped tube—i.e. even when the tube is uncapped prior to insertion of the swab, the transport buffer solution cannot spill out. Once the swab has been used to take the sample, the seal can be peeled off or the tip of the swab pushed down to pierce this seal and to pass into the transport buffer solution. The specialised cap described above is then used to seal the tube. The swab contents are then eluted into the transport buffer as above.

Variant B: the specialised cap can be screwed down or fixed on to the tube after the swab has been dropped into it; the cap cannot however be unscrewed in normal use; any attempt to remove the cap will harm or damage the cap, giving clear tamper evidence. This can be important when samples tubes need to adhere to chain of custody rules, e.g. for forensic evidence.

Another variant, variant C, is that the kit supplied to enable a swab to be taken includes (a) a tube with a buffer solution; (b) a standard, solid cap, screwed or attached to the tube; (c) a swab. Once the swab is taken and dropped into the tube and the conventional cap placed back on to the tube, the tube is then moved to a diagnostics machine; it is placed, together with a number of other similar tubes, in a rack that typically holds 24 tubes, as described above. The standard cap on each tube is then replaced (e.g. manually by a technician) with the specialised cap and the rack then moved into the diagnostics machine.

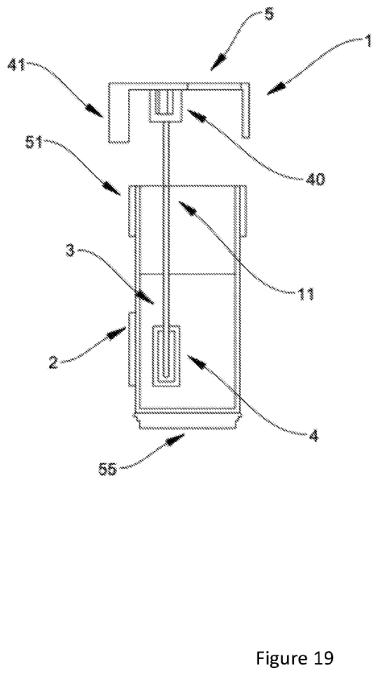

In variant D, shown in FIG. 19, the cap 1 includes, on its inner face (facing down into the tube 2) a mating socket 40 into which the shaft 11 of the swab can be inserted after it has taken the sample: the swab head 4 is retained inside the tube 2 by inserting the end of the broken shaft 11 (i.e. at the opposite end to the absorbent swab material) into a mating socket 40 on the underside of the specialised cap 1. The cap 1 is then placed back on to the tube 2 and secured; the swab head 4 is now safely retained inside the tube 2. The mating socket 40 may be offset from the centre of the cap 1 so that the swab head 4 and its shaft 11 are also offset from the centre of the tube 2; the purpose of this offsetting will be explained below.

This FIG. 19 shows the following features of the cap 1:
Pierceable film 5 within the cap 1
Single protruding feature 41 to orientate tube, swab and pierceable film in the diagnostics machine
Offset mating socket 40 for swab shaft 11
QR code 55 on the base of the tube 2

Tubes, as that term is used in this specification, may be:
flat bottomed or conical in shape or have any other shape
may not have a QR code underneath
maybe a push fit or clipped on cap rather than both portions be threaded

In variant E, the specialised cap includes, on its outer face (facing away from the tube) a socket for the swab shaft. The cap is threaded as a normal tube cap with an internal or external thread which marries up to the thread on the outside of or on the inside of the top of the sample tube. In this example the tube contains a transport buffer and after the swab is taken and contains mucus, the shaft of the swab is shortened by breaking at the pre-determined break point against the inside wall of the tube and may be inserted into the socket that is on the outside of the cap.

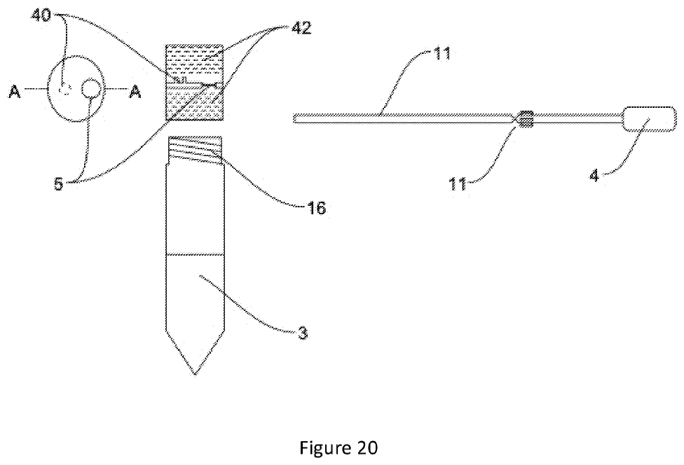

In variant F, the cap 1 is internally double threaded 42 so as to be used to seal the tube 2 containing the transport buffer 3 (see FIG. 20). The shaft 11 of the swab, after sampling, is shortened by breaking at the pre-determined break point 43 and may then be inserted with a friction fit into the socket 40 that is at this time on the outside of the cap 1. The cap 1 is un-screwed from the tube and is then inverted to place the shaft 11 and swab end 4 into the transport buffer 3 within the tube 2. The cap 1 and tube 2 are screwed together to completely seal the contents into the tube 2.

In variant G, on the outside of the cap there may be a single or multiple protruding elements that are similar to a gear tooth. This or these protrusions are positioned in relation to the swab and its position within the tube; the projections are used as a datum point for an auto-pipetting station or test platform to locate the pierceable film section of the tube cap. This enables the pierceable film to be accurately located and pierced by a pipette tip or needle and for the transport buffer with the eluted contents of the swab or the bodily fluid to be aspirated from the tube up in to the needle or pipette tip and thereafter transported safely within the auto-pipette station or test platform, into another container or vessel for further liquid handling, manipulation and testing.

If the swab end is not inserted into a socket in the cap, but simply sinks to the bottom of the buffer solution in the tube, then the pierceable film seal or seals can be centralised in the cap without the need for the single or multiple protrusions on the outside of the cap. The liquid handling system will pierce the foil/s in the centre of the cap, as explained for the primary implementation.

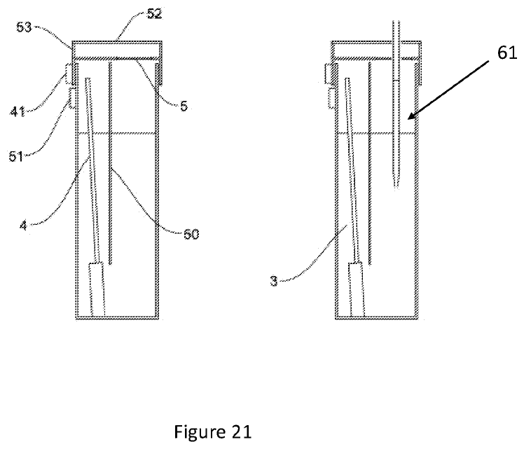

In variant H, shown in FIG. 21, the tube includes an internal partition 50. It might be difficult to slot the broken shaft 11 of the swab into the underside of the cap socket 40. So this variant H includes a partition 50 across the body of the tube 2. The partition 50 does not go fully down to the bottom of the tube 2, in order to allow the biological sample on the swab to be washed in the transport liquid 3. But the partition 50 enables the pipette tip (not shown) to come down into the tube 2, without coming into contact with the swab head 4 and its shaft 11 and becoming fouled or blocked or otherwise interfered with.

The cap 1 fits and closes accurately in relation to the swab partition 50 and foil section 5; to ensure it is fully closed, a registration projection 41 is moulded in to the cap; when this is aligned with a matching projection 51 on the outside of the tube 2, the tube is fully closed in order to prevent leaks from the cap 1 not being fully tightened down on to the tube 2.

The registration projection 51 or point may be a notch or protrusion on the side of the tube 2 that meets or aligns with a similar feature 41 on the cap when fully closed to ensure that:
When placed in a rack all the seals on the numerous tubes within the rack are all in a similar inclination
That an auto-pipette system can be programmed with the accurate location of the pierceable portion of sealing film, allowing the pipette time to pierce through the aperture and for the biological sample to be aspirated from the sample tube
An upstand around the rim that stands proud of the horizontal portion of the cap and allows a secondary film to be sealed across the top of the whole cap, in order to provide greater biosecurity protection to the tube and cap whilst in transit.

The physical notch would be below the external thread of the tube to allow the female thread on the tube to match and seal well with the male thread of the cap.

The dividing wall or partition lies cross the width of the sample tube but only within part of the height of tube, to allow the free circulation of the tube buffer medium around the swab and within the body of the tube. The dividing wall prevents the pipette tip from being blocked, fouled or impeded in anyway, including up and down, by the swab shaft (spindle) or by the absorbent end material of the swab.

FIG. 21 shows how the removable cap 1 to the tube 2 can include an additional top film layer 52 that covers the lower film 5; it is the lower film that includes the small circular pierceable film section 5 described earlier. The top film layer 52 provides added bio-security after the sample has been taken, placed into the buffer in the tube and the cap 1 replaced. The top film layer 52 is mounted on upstand 53 and can be opaque to prevent or obscure sight of the small circular pierceable film section 5 in the lower film.

### Sample Kit Variants

Different Sampling Kits are Possible:

Sample Kit 1 includes:
A swab with a shaft that can be broken at a predetermined point once the sample has been taken
A tube cap that has a socket to accept and hold the swab within the tube; a portion of the cap is a made of a pierceable film
A tube that is sealed with a film that holds a travel buffer the seal of which is pierced by the swab end

Sample Kit 2 includes:
A swab with a shaft that can be broken at a predetermined point once the sample has been taken
A tube cap, a portion of which is a made of a pierceable film
An unsealed tube

Sample Kit 3 includes:
A swab with a shaft that can be broken at a predetermined point once the sample has been taken
A tube cap a portion of which has a pierceable film within it
A tube that is sealed with a film that holds a travel buffer the seal of which is pierced by the swab end

Sample Kit 4 includes:
A swab with a shaft that can be broken at a predetermined point once the sample has been taken
A cap with a pierceable film that fits a BD Vacutainer tube (or equivalent) after blood has been taken and is used in place of the rubber cap supplied with the Vacutainer

Sample Kit 5 includes:
A swab with a shaft that can be broken at a predetermined point once the sample has been taken
A simple capped tube which contains a liquid transport buffer
A replacement single or double foiled sealed cap that is non-locking
A swab with a shaft that can be broken at a predetermined point once the sample has been taken

Sample Kit 6 includes:
A swab with a shaft that can be broken at a predetermined point once the sample has been taken
A non-locking capped tube which contains a liquid transport buffer where the cap contains a single or double foil seal but is non-locking when screwed down

All sample kits could also include the push fit cap 24A or the screw fit cap 24C to provide extra protection to the pierceable film 5 during transit.

All kit types will be contained within a polyethylene fiber pouch, e.g. a Tyvek™ pouch, that has been sterilized and all nucleic acid (RNA and DNA) destroyed by filling with ethylene oxide gas if the cap has a single seal or gamma radiation sterilized if it has a double seal where it would be impossible for the ethylene oxide gas to sterilize the air gap between the two foils or seals.

Tubes may:
be flat bottomed or conical in shape
have a QR code underneath
not have a QR code underneath
have a push fit or clipped on cap that lock together with some other non-threaded locking arrangement, rather than both portions be threaded
have a bar code stuck onto the side of the tube

have a locking feature to allow them to lock into a test tube rack so that they remain locked into the rack when the pipette tip is extracted together with some of the sample buffer

### APPENDIX 1: KEY FEATURES

This appendix summarises key feature A implemented in the system, as well as a broad range of optional features. Note that each and all optional features can be combined with Key Feature A, as well as one another.

### Key Feature A.

A cap for a pathogen sample tube, the tube having an open end and the cap being configured to secure the open end of the tube to prevent spillage of any sample stored in the tube; in which the cap includes a first pierceable protective film section configured to enable an automated pipette or other sample withdrawal system to pierce the protective film section and to aspirate at least some of the sample.

### Optional Features

### The Cap

the cap includes a plastic body with a screw thread that securely attaches to a thread around or within the tube
the cap is configured to secure or lock to the tube using a push fit, clip or other non-threaded locking arrangement.
the cap includes a plastic body and the first pierceable protective film section is attached across an opening in the plastic body
the cap includes a second pierceable protective film section lying underneath the first pierceable protective film section
the second pierceable protective film section is attached across an opening in the plastic body
at least one of the pierceable protective film sections is heat welded to the plastic body of the cap
the first and second pierceable protective film sections are separated by an air gap, such as an air gap that is approximately 2 mm in depth
the first and second pierceable protective film sections provide compliance with UN3373 Category B, Packaging Requirements for Biological and Infectious Substances.
the cap is gamma radiation sterilised in order to sterilise the cap and in particular the air gap between the film sections.
the second pierceable protective film section is smaller than the first pierceable protective film section to enable each film section to be welded to the cap from one side
The or each pierceable protective film section comprises thin polymer film
The or each pierceable protective film section is made entirely of thin polymer film
the or each pierceable protective film section is made from or comprises a thin metal foil
the or each pierceable protective film section is made from or comprises a thin aluminium foil
the or each pierceable protective film section is made from or comprises a thin aluminium foil that is approximately 25 microns thick, with a thin lacquer coating on its upper side and a co-extrusion coating, such as a polymer coating on the lower side
at least one of the pierceable protective film sections is shaped as a disc
the or each pierceable protective film section is configured to be pierced at a position corresponding to the central long axis of the tube
at least one of the pierceable protective film sections is substantially circular and placed centrally in a cap, which is also substantially circular
the cap includes a circular ridge that surrounds the film section, protecting the film section from being inadvertently damaged.
the or each pierceable protective film section is opaque
one or both of the pierceable protective film sections is made of self-sealing film that, once the sample has been extracted or aspirated and the pipette tip or needle removed, then re-seals in order to prevent leakage or escape of any pathogen from the tube.
the cap includes an internal thread to engage with a corresponding thread on the outside of the tube, and also includes a tapered deformable section that is configured to grip the internal surface of the tube as the cap is tightened to act as a bung for the tube.
the pierceable film(s) are large enough so that a complete disposable pipette or needle tip, after use, can be ejected and dropped into the sample tube, through the pierceable film(s), where it is retained for biosecurity and to reduce the volume of waste material.
the cap is not removable from the tube in ordinary use, once it has been used to close the tube with a sample in the tube
the cap includes a socket into which a shaft of a swab can be fitted
the socket is offset from the centre of the cap
the cap includes a location feature to enable an automatic pipette or sample withdrawal system to physically locate or register against the tube to enable the pipette or other withdrawal system to pierce the film(s) in the correct position, such as the central axis of the tube.
the cap includes a lid above the first pierceable protective film section, configured to protect the first pierceable protective film section
the lid is a push-on lid
the lid is a screw. on lid

### The Tube

the tube includes a removable or pierceable seal that seals the inside of the tube prior to a sample or a swab being placed inside the tube.
the tube includes a removable or pierceable seal that seals the inside of the tube to cover a buffer solution in the tube and which is configured to be removed prior to a swab being dropped or placed into the buffer solution.
the tube includes a QR code or other unique ID, such as on its base.
the tube is flat bottomed or conical or has any other shape.
the tube includes a location feature configured to enable an automatic pipette or sample withdrawal system to physically locate or register against the tube to enable the pipette or other withdrawal system to pierce the film(s) in the correct position, such as the central axis of the tube.
the tube includes an internal partition configured to prevent a swab head or shaft in the tube from interfering with the automatic pipette or sample withdrawal system
the partition does not extend down to the base of the tube
the partition is configured to enable buffer medium to circulate freely through the tube.
there are one or more physical features included on both the cap and the tube, and they align with each other when the cap is fully closed or secured.
physical features are included on both the cap of the tube and the body of the tube and ensure that sample tubes, when placed in a rack, all have the their protective film or layer oriented in the same or a similar inclination
physical features are included on both the cap of the tube and the body of the tube and ensure that an auto-pipette system can be programmed with the accurate location of the pierceable portion of sealing film allowing the pipette time to pierce through the aperture and for the biological sample to be aspirated from the sample tube
physical feature is a notch or protrusion
physical feature engages with a corresponding feature in the automated pipette or other sample withdrawal system,
physical feature is visual pattern that enables a machine vision system to accurately locate and/or orient the tube

### Cap and Tube Locking

the cap includes a tab or other feature below its internal thread and the feature is configured, as the cap is turned in one direction to close down on the tube, to ride up a ramp feature in an annular ridge in the tube, to deform the cap and to then permanently locate the tab below the annular ridge.
the cap is prevented from being turned in the other direction by a stop feature in the annular ridge.
as the tab or other feature locks into place below annular ridge, an annular sealing surface in the cap seals against the annular top of the tube.

### The Rack

the cap when in combination with the tube and when sealing the tube, and where the tube is retained in a rack that includes multiple tube holders, each configured to receive and retain one of the tubes
the rack includes an aperture below each tube holder so that a QR code or other unique ID on a tube can be read by an automated system viewing the unique ID through the aperture
each tube holder retains a tube using an interference fit that is sufficient to ensure that the tube remains securely in the rack during the insertion and withdrawal of the pipettes or other sample withdrawal device
each tube holder retains a tube using a physical feature, or a screw or a bayonet fitting
a lid is configured to be secured over the tubes in the rack to ensure that the tubes remain securely in the rack during the insertion and withdrawal of the pipettes or other sample withdrawal device.
the lid locates and fits against a physical feature in each cap, such as a circular ridge or groove running around the top of each cap or crenelations on the side of each cap
the rack holds 24 tubes in a 6×4 array
the rack conforms in size to the ANSI/SLAS (SBS) standard for microplates
each rack with is grouped into a set of multiple racks and the set of multiple racks are then processed by the automated pipette or other sample withdrawal system
once all tubes in a rack have been aspirated, the rack is configured to be automatically covered in a plastic film, such as a plastic that is secured to the top of the tubes or secured over any lid, to enable safe disposal of the entire rack, including the aspirated tubes.
the rack includes a QR code, bar code or other unique identifier.
the rack includes one or more locking features that secure the rack to a baseplate of the auto-pipette, liquid handling platform or other sample withdrawal system.

### Auto-Pipette System

the automated pipette or other sample withdrawal system uses disposable pipettes or needles
the automated pipette or other sample withdrawal system extracts the sample from a tube and delivers it to another tube or a well, for a sample analysis system, such as a PCR thermal cycler or nucleic acid extraction platform
the sample analysis system is as an automated test platform that performs a nucleic acid (RNA or DNA) extraction using magnetic beads followed by PCR thermal cycling to determine and quantify the presence of a pathogen
the automated pipette or other sample withdrawal system includes a baseplate with one or more features configured to engage with one or more co-operating features on the rack to secure the rack to the baseplate.

### Swab

the cap when in combination with the tube and in combination with a swab
the swab includes a head, and a shaft that is configured to be breakable at a specific region along the shaft to enable the head and a portion of the shaft to be deposited or positioned in the tube
the swab includes a head that is designed to sink when dropped into a buffer solution
the swab includes a flocked nylon head that is designed to sink when dropped into a buffer solution

### Sample

sample includes a transport buffer solution
sample includes a swab in a transport buffer solution
sample includes a human or animal fluid
sample includes a human or animal tissue sample
sample includes organic material e.g. plant material

### The Kit

A kit including (a) a cap as defined above; (b) a pathogen sample tube; and (c) a swab.
The kit includes: (a) swab with a shaft that can be broken at a predetermined point; (b) the cap, configured to include a socket to accept and hold the swab within the tube; (c) a tube that is sealed with a film that holds a travel buffer the seal of which is configured to be pierceable by the swab end or head.
The kit includes: (a) a swab with a shaft that can be broken at a predetermined point; (b) the cap; (c) an unsealed tube.
The kit includes: (a) a swab with a shaft that can be broken at a predetermined point; (b) the cap; (c) a tube that is sealed with a film that holds a travel buffer, the seal of which is pierceable by the swab end or head.
The kit includes: (a) a swab with a shaft that can be broken at a predetermined point; (b) the cap, configured to fit a BD Vacutainer tube or equivalent.
The kit includes: (a) a swab with a shaft that can be broken at a predetermined point; (b) a conventional cap; (c) a tube which contains a liquid transport buffer and is closed by the conventional cap; (d) the cap.
The kit includes: (a) a swab with a shaft that can be broken at a predetermined point once the sample has been taken; (b) a tube which contains a liquid transport buffer; (c) the cap, not locked down on to the tube.

What is claimed is:

1. A method of automated aspiration of a sample in a pathogen sample tube, the tube having an open end and being capped with a cap configured to secure the open end of the tube to prevent spillage of the sample stored in the tube;
in which the cap includes a lower pierceable protective rubber film and an upper plastic film, the method comprising passing a glass or plastic pipette tip that is connected to an automated pipette sample withdrawal system through the upper and lower films and aspirating at least some of the sample.

2. The method of claim 1 in which the lower pierceable protective rubber film and the upper plastic film are separated by an air gap, such as an air gap that is approximately 2 mm in depth.

3. The method of claim 1 in which the first and second pierceable protective film sections provide compliance with UN3373 Category B, Packaging Requirements for Biological and Infectious Substances.

4. The method according to claim 1 in which the lower pierceable protective rubber film is a self-sealing film that, once the sample has been extracted or aspirated and the pipette tip removed, then re-seals in order to prevent leakage or escape of any pathogen from the tube.

5. The method of claim 1 which the cap includes an internal thread to engage with a corresponding thread on the outside of the tube, and also includes a tapered deformable section that is configured to grip the internal surface of the tube as the cap is tightened to act as a bung for the tube.

6. The method of claim 1 in which the cap includes a socket into which a shaft of a swab can be fitted.

7. The method of claim 1 in which the cap or tube includes a location feature to enable an automatic pipette system to physically locate or register against the tube to enable the pipette tip to pass through the upper plastic film and the lower pierceable protective rubber film in the correct position, such as the central axis of the tube.

8. The method of claim 1 in which the tube includes a QR code or other unique ID, such as on its base.

9. The method according to claim 1 in which a visual pattern enables a machine vision system to accurately locate and/or orient the tube.

10. The method of claim 1 wherein a plurality of the pathogen sample tubes are retained in a rack that includes multiple tube holders and wherein the plurality of pathogen sample tubes are aspirated simultaneously by a corresponding plurality of automated glass or plastic pipette tips.

11. The method of claim 10 in which the rack includes an aperture below each tube holder so that a QR code or other unique ID on a tube can be read by an automated system viewing the unique ID through the aperture.

12. The method of claim 10 in which each tube holder retains a tube using an interference fit or a lid is secured over the tubes in the rack to ensure that the tube remains securely in the rack during the insertion and withdrawal of the pipette tips.

13. The method of claim 10 in which a lid is configured to be secured over the tubes in the rack to ensure that the tubes remain securely in the rack during the insertion and withdrawal of the pipette tips.

14. The method of claim 10 in which a multiple number of the racks are grouped into a set and the set of multiple racks is then processed by the automated pipette.

15. The method according to claim 10 in which the rack includes a QR code, bar code or other unique identifier.

16. The method according to claim 10 in which the rack is secured to a baseplate of an auto-pipette liquid handling platform and wherein the rack includes one or more locking features that secure the rack to the baseplate.

17. The method of claim 1 in which the automated pipette extracts the sample from the sample tube and delivers it to another tube or a well of a PCR thermal cycler or nucleic acid extraction platform.

18. The method of claim 1 in which the sample is delivered to an automated test platform that performs a nucleic acid (RNA or DNA) extraction using magnetic beads followed by PCR thermal cycling to determine and quantify the presence of a pathogen.

19. The method of claim 1 wherein the upper plastic film is a pre-cut plastic film.

20. The method of claim 10 wherein the upper plastic film is a pre-cut plastic film and wherein each tube holder retains a tube using a sheet with corresponding cut out openings secured over the tubes in the rack to ensure that the tube remains securely in the rack during the insertion and withdrawal of the pipette tips.

21. The method of claim 1 in which the automated pipette extracts the sample from the sample tube and delivers it to another tube or a well in a microtiter plate that is used in a PCR thermal cycler or to a tube used in a nucleic acid extraction platform.
